(19) United States
(12) Patent Application Publication
(10) Pub. No.: US 2005/0005174 A1
(43) Pub. Date: Jan. 6, 2005

(54) Configurable password authentication policies

(75) Inventor: Thomas W. Connors, Rochester, NY (US)

Correspondence Address: Kermit D. Lopez / Luis M. Ortiz;Ortiz & Lopez, PLLC, Patent Attorneys, P.O. Box 4484, Albuquerque, NM, 87196-4484, US

(73) Assignee: Xerox Corporation

(21) Appl. No.: 10/465,059

(22) Filed: Jun. 18, 2003

(51) Int. Cl. H04L 9/00

(52) U.S. Cl. 713/202

(57) ABSTRACT

Embodiments permit privileged administrators of computer networks to configure authentication policies. One or more authentication policies can be associated with a computer network. A customer administrator or other privileged person can be permitted to configure one or more of the authentication policies according to particular preferences of the customer administrator or privileged person. The methods and systems can provide enablement/disablement configuration capabilities that can allow a customer administrator or other privileged administrator to select and configure appropriate authentication policies in the context of accessing a computer network.

### TECHNICAL FIELD

Embodiments generally relate to remote computer networks, such as the Internet and the like. Embodiments also relate to methods and systems for accessing computer networks and particular information maintained therein. Additional embodiments are related to methods and systems for accessing a managed service environment through a computer network.

### BACKGROUND OF THE INVENTION

In many instances it can be necessary to authenticate particular computer network end-users in order to primarily permit such end-users access to data maintained in information repositories by the computer network and other systems. Also, it may be desirable, especially In a managed service environment, to permit privileged installers and administrators of network services to configure authentication polices and processes, thereby providing for example, a re-usable architecture that satisfies individual customer authentication policy requirements.

Current access and authentication systems do not usually allow customers to select which password authentication policies for authenticating a user are to be employed in the solution, particularly in a managed service environment. Customers include, for example, organizations or entities that rely upon a managed service for functions such as recording documents and maintaining copies of such documents in databases and other repositories. Customers generally wish to access data at their convenience.

Some customers may desire, for example, to access data via a managed service utilizing extensive and highly secure authentication policies and processes, while others simply may be satisfied with much broader authentication polices such as a simple password. A challenge faced by managed service providers is the ability to provide varying authentication policies for accessing customer data and to do so in both a customer-friendly and cost-efficient manner.

Traditional authentication systems usually allow only limited changes within a given authentication policy by directly modifying the operating system (e.g. UNIX) parameters. To preserve security of the overall managed services environment, managed service providers may not currently permit customers direct access to managed services infrastructure operating systems, which control authentication policies.

An evaluation of current access and authentication systems reveals that in order to be truly efficient and oriented toward the customer, a system should accommodate custom configurations to best meet customer preferences. Thus, a reusable design should be deployed toward specific customer needs. To that end, unique methods and systems for configuring authentication policies and processes are disclosed herein.

### BRIEF SUMMARY

It is a feature of the present invention to provide improved methods and systems and more specifically, systems for accessing computer networks and particular information maintained therein.

It is another feature of the present invention to provide improved computer and computer network authentication methods and systems.

It is also a feature of the present invention to provide methods and systems in a managed service environment for permitting customer administrators and/or other privileged customer personnel to configure authentication policies, including password authentication polices, associated with a computer network and related systems, such as a managed service environment.

Aspects of the present invention relate to one or more authentication policies that are associated with a computer network. Such authentication policies describe the manner in which an end-user may access a managed service environment implemented by a computer network. A customer administrator or other privileged person can be permitted to configure one or more authentication policies according to particular preferences of the customer administrator or privileged person. The methods and systems illustrated herein can provide, in accordance with embodiments thereof, for enablement/disablement configuration capabilities, which allow a customer administrator or other privileged administrator to select and configure appropriate authentication policies in the context of accessing a managed service environment through a computer network.

### BRIEF DESCRIPTION OF THE DRAWINGS

The accompanying figures, in which like reference numerals refer to identical or functionally-similar elements throughout the separate views and which are incorporated in and form part of the specification, further illustrate embodiments of the present invention.

FIG. 1 illustrates a block diagram illustrative of a client/server architecture system in which a preferred embodiment of the present invention can be implemented;

FIG. 2 illustrates a detailed block diagram of a client/server architectural system in which an embodiment of the present invention can be implemented;

FIG. 3 illustrates a high-level network diagram illustrative of a computer network, in which an embodiment of the present invention can be implemented; and

FIG. 4 illustrates a block diagram of a system in which customer administrators or other privileged customer personnel can configure authentication polices in accordance with an embodiment of the present invention.

### DETAILED DESCRIPTION OF THE INVENTION

The particular values and configurations discussed in these non-limiting examples can be varied and are cited merely to illustrate an embodiment of the present invention and are not intended to limit the scope of the invention.

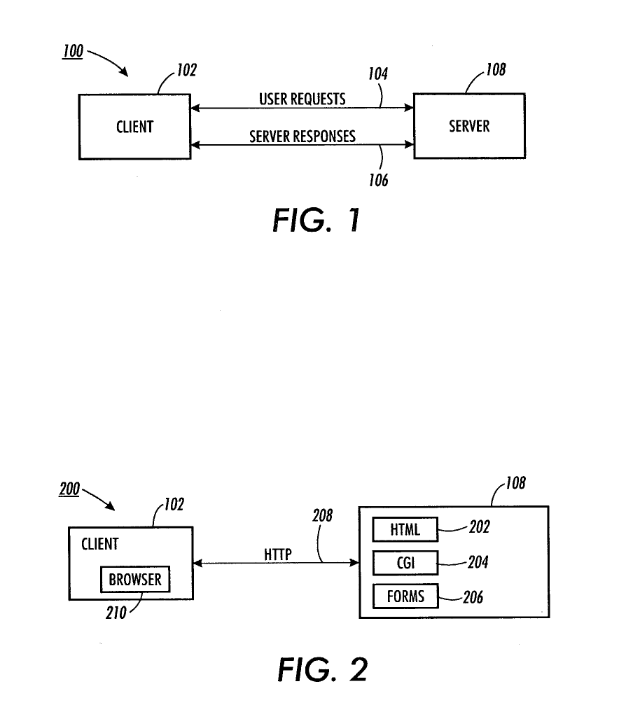

FIG. 1 illustrates a block diagram illustrative of a client/server architecture system 100 in which embodiments can be implemented. It can be appreciated by those skilled in the art that the system illustrated with respect to FIGS. 1 to 3 is an example of one type of computer network in which the present invention can be implemented, particularly in the context of a managed service environment. Properly authenticated end-users of a managed service environment can therefore access data, such as customer documents, which are contained in information repositories.

In a managed service environment, an end-user from one organization (e.g. a customer organization) typically accesses the managed service environment over a computer network to retrieve desired data. Another organization usually oversees the operations and functions of the managed service environment and the computer network thereof, including the processing and storage of data valuable to the customer organization.

For example, a national automobile sales company may require processing and storage of accounting and financial data relating to yearly car sales. The automobile sales company (i.e., the customer) may hire an outside organization to handle electronic processing and compilation of such accounting and storage data via a managed service environment. An employee of the automobile sales company may desire to retrieve such data at his or her convenience, but a privileged administrator of the company sets the particular level of authentication required by the employee (i.e., an end-user) to access the desire data.

Other types of computer networks can also be utilized in accordance with alternative embodiments of the present invention, such as, for example, token ring networks, Intranets or organizationally dedicated computer networks rather than a more open computer network, such as the Internet. FIGS. 1-3 are thus presented for illustrative purposes only and are not considered limiting features of the present invention.

As indicated in FIG. 1, user requests 104 for data can be transmitted by a client 102 (or other sources) to a server 108. Server 108 can be implemented as a remote computer system accessible over the Internet, the meaning of which is known, or other communication networks. Note that the term “Internet” is well known in the art and is described in greater detail herein. Also note that the client/server architecture described in FIGS. 1, 2 and 3 represents merely an exemplary embodiment. It is believed that the present invention can also be embodied in the context of other types of network architectures, such as, for example company “Intranet” networks, token-ring networks, wireless communication networks, and the like.

Server 108 can perform a variety of processing and information storage operations. Based upon one or more user requests, server 108 can present the electronic information as server responses 106 to the client process. The client process may be active in a first computer system, and the server process may be active in a second computer system, communicating with one another over a communications medium, thus providing distributed functionality and allowing multiple clients to take advantage of information processing and storage capabilities of the server, including information retrieval activities such as retrieving documents from a managed service environment.

FIG. 2 illustrates a detailed block diagram of a client/server architectural system 200 in which an embodiment can be implemented. Although the client and server are processes that are generally operative within two computer systems, such processes can be generated from a high-level programming language, which can be interpreted and executed in a computer system at runtime (e.g., a workstation), and can be implemented in a variety of hardware devices, either programmed or dedicated.

Client 102 and server 108 communicate utilizing the functionality provided by HTTP. Active within client 102 can be a first process, browser 210, which establishes connections with server 108, and presents information to the user. Any number of commercially or publicly available browsers can be utilized in various implementations in accordance with the preferred embodiment of the present invention. For example, a browser can provide the functionality specified under HTTP. A customer administrator or other privileged individual or organization can configure authentication policies, as indicated herein, using such a browser.

Server 108 can execute corresponding server software, such as a gateway, which presents information to the client in the form of HTTP responses 208. A gateway is a device or application employed to connect dissimilar networks (i.e., networks utilizing different communications protocols) so that electronic information can be passed or directed from one network to the other. Gateways transfer electronic information, converting such information to a form compatible with the protocols used by the second network for transport and delivery. Embodiments can employ Common Gateway Interface (CGI) 204 for such a purpose.

The HTTP responses 208 generally correspond with “Web” pages represented using HTML, or other data generated by server 108. Server 108 can provide HTML 202. The Common Gateway Interface (CGI) 204 can be provided to allow the client program to direct server 108 to commence execution of a specified program contained within server 108. Through this interface, and HTTP responses 208, server 108 can notify the client of the results of the execution upon completion.

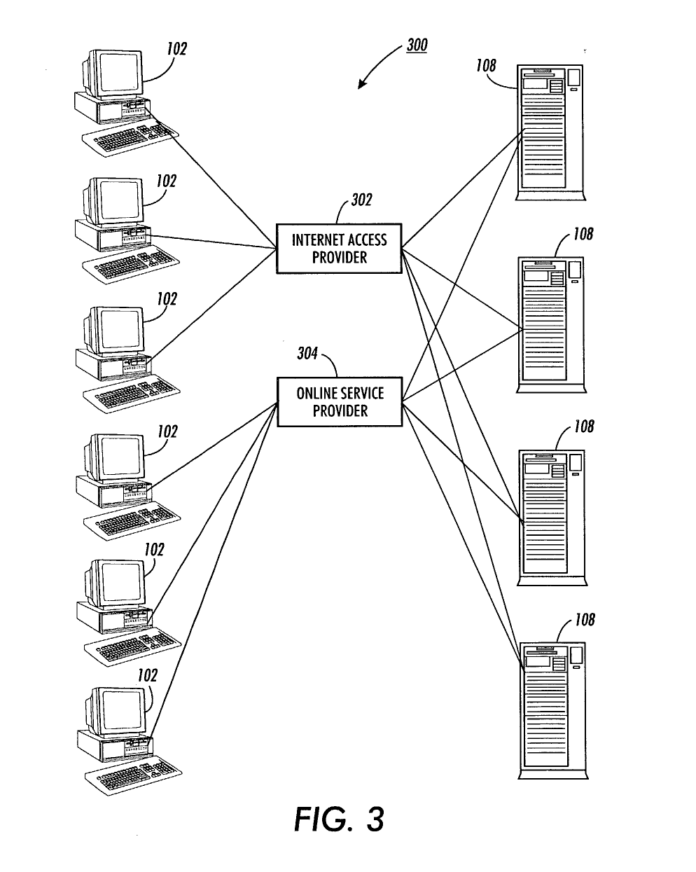

FIG. 3 illustrates a high-level network diagram illustrative of a computer network 300, in which embodiments can be implemented. Computer network 300 can be representative of the Internet, which can be described as a known computer network based on the client-server model discussed herein. Conceptually, the Internet includes a large network of servers 108 that are accessible by clients 102, typically users of personal computers, through some private Internet access provider 302 or an on-line service provider 304.

Each of the clients 102 can operate a browser to access one or more servers 108 via the access providers. Each server 108 operates a so-called “Web site” that supports files in the form of documents and web pages. A network path to servers 108 is generally identified by a Universal Resource Locator (URL) having a known syntax for defining a network collection. Computer network 300 can thus be considered a Web-based computer network.

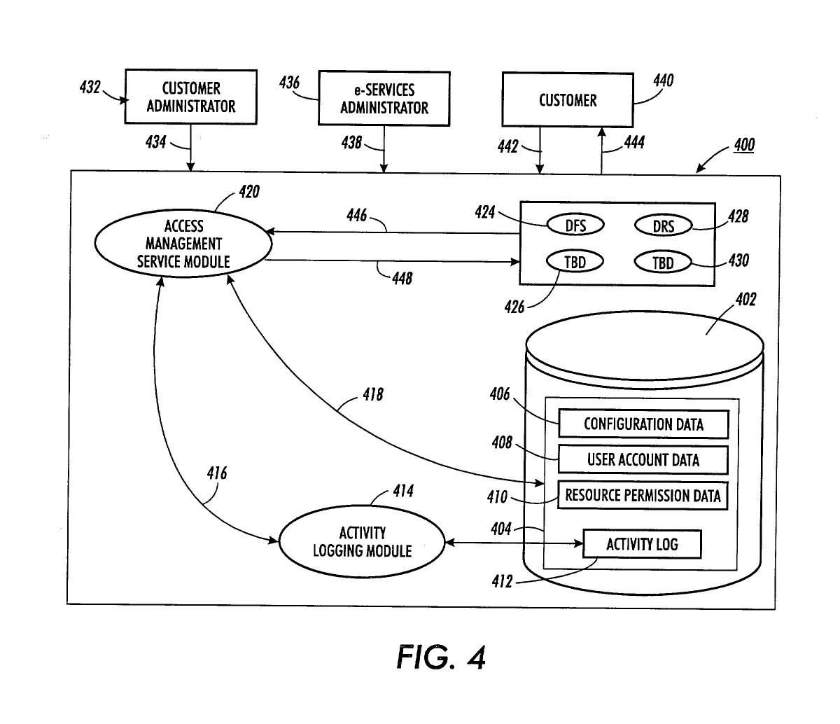

FIG. 4 illustrates a block diagram of a system 400 in which customer administrators or other privileged customer personnel can configure authentication polices in accordance with a preferred embodiment of the present invention. System 400 can function as part of a managed service environment and can be implemented as a Digital Services Platform (DSP). System 4400 allows access to particular services to authorized customers 440. System 400 permits a customer administrator 432 or other privileged personnel to configure authentication polices, such as, for example, authentication password polices, which can permit an end user, such as customer 440, access to system 400 and services thereof.

The authentication policy generally describes the manner in which a user may access the computer network. Example authentication polices also can include, for example, the minimum and maximum number of characters in a password, the minimum and maximum number of alphabetic characters in the password, the minimum and maximum number of digits in the password, enforcement of rules against password and login name being the same, and so forth.

The architecture depicted in FIG. 4 can facilitate resolution of conflicts arising from the configured authentication policies. The configuration data 406 can include precedence rules dictating the order of policy enforcement and/or noting which authentication policies/rules cannot be enabled if the policy of interest is enabled. For example, when the enforcement of authentication policy prevents the proper enforcement of authentication policy B, and if the privileged administrator enables policy A, system 400 would prevent the privileged administrator from enabling policy B. Alternatively, if policy B were so enabled with policy A, the precedence rules would force the system to enforce one policy over the other.

An e-services administrator 436 is generally associated with a managed service environment, such as system 400. The e-services administrator 436 generally refers to an individual or a group of individuals, belonging to an e-services team (i.e., managed service environment), who can administer and configure system 400. The customer administrator 432 generally refers to an individual or a group of individuals belonging to a customer base, who can administer and configure system 400 within the constraints configured by the e-services administrator 436.

System 400 generally includes an access management service module 420, which can communicate with DSP services 422, which includes a digital fulfillment service (DFS) 424, digital repository service (DRS) 428, “to be determined” (TBD) 426 and TBD 430. TBD 426 and TBD 430 represent other types of services, which may also be provided via system 400. It can be appreciated by those skilled in the art that DFS 424, DRS 428, TBD 426, and TBD 430 may not be considered specific features of the present invention, but are primarily presented for illustrative and exemplary purposes only.

Line 446 indicates a request for resource access, while line 448 indicates a response thereof. Access management service module 420 can communicate with a DSP relational database 402 that includes access management module data 404, which is further composed of configuration data 406, user access data 408, and resource permission data 410. Database 402 can also store an activity log 412, which is accessible by an activity logging module, which in turn can communicate with access management service module 420, as indicated by line 416. Communications between access management module 420 and database 402 are also indicated by line 418.

Line 416 indicates activity log updates and retrieval activities, while line 418 indicates data updates and retrieval activities. In general, a customer administrator 432 can communicate with system 400, as indicated by line 434, which also represents an access management module configuration. Similarly, an e-services administrator can communicate with system 400, as indicated by line 438, which also represents an access management module configuration. A customer 440 can also request resource access and response as indicated by lines 442 and 444.

In general, system 400 can represent an access management system and/or a DSP platform, as indicated earlier. System 400 can be implemented in the context of a computer network such as computer network 300 of FIG. 3. A solution refers generically to an e-services customer deliverable, which can be composed of DSP services in response to particular business objectives and requirements set forth by customer 440. The term “services” as utilized herein generally refers, for example, to a logical grouping of software that performs useful actions within the solution. The term customer can refer, for example, to the organization that has secured e-services to provide DSP based resources to meet their business needs. A “requester refers, for example, to the service, such as an end-user, requesting actions from system 400.

The e-services administrator 436 can manage one or more data repositories. In content-based marketing, for example, administrator 426 could manage product and services information and learning processes for content-based marketing customers, such as, for example, customer 440. System 400, implemented as a DSP, can provide Internet-based access to offerings including digital document storage, retrieval, and presentation and print fulfillment. Customers may require that digital assets managed by an e-service DSP be available only to those specific customers that the customer administrator identifies and authorizes. Additionally, e-services business partners offering services as part of a DSP platform may require that only identified and authorized customers are allowed access to their offerings.

Embodiments can be implemented in the context of modules. In the computer programming arts, a module can be typically implemented as a collection of routines and data structures that performs particular tasks or implements a particular abstract data type.

Modules generally are composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

Examples of suitable modules include the access management service module 420 and activity-logging module 414 depicted in FIG. 4. In accordance with an embodiment, an access management service module 420 can be utilized for associating one or more authentication policies with the computer network, such that the authentication policies thereof describe the manner in which an end-user may access the computer network. The access management service module 420 can also be utilized to permit a privileged administrator of the computer network to configure the authentication policies according to a preference of the privileged administrator can be implemented.

The access management service module 420 generally permits an end-user access to one or more services of the computer network. Examples of such services include, but are not limited to DFS 424 and DRS 428 as illustrated in FIG. 4. The access management service module 420 can operate in association with the activity logging module 414 and database 402, which includes configuration data, user account data, resource permission data and an activity log accessible by the privileged administrator for configuration of one or more of the authentication policies.

It is appreciated that various other alternatives, modifications, variations, improvements, equivalents, or substantial equivalents of the teachings herein that, for example, are or may be presently unforeseen, unappreciated, or subsequently arrived at the applicants or others are also intended to be encompassed by the claims and amendments thereto.

1. A privileged administrator computer network authentication policy configuration method comprising:
initially designating at least one authentication policy describing a manner in which an end-user may access a managed service environment implemented by a computer network;
permitting a privileged administrator of said managed service environment to configure said at least one authentication policy according to a preference of said privileged administrator; and
thereafter configuring said at least one authentication policy, in response to a particular input by said privileged administrator.

2. The method of claim 1 further comprising selecting said at least one authentication policy, in response to a particular input by said privileged administrator.

3. The method of claim 1 further comprising disabling said at least one authentication policy, in response to a particular input by said privileged administrator.

4. The method of claim 1 further comprising enabling said at least one authentication policy, in response to a particular input by said privileged administrator.

5. The method of claim 1 further comprising automatically facilitating a resolution of at least one conflict arising from configuring said at least one authentication policy according to a preference of said privileged administrator.

6. The method of claim 1 wherein designating at least one authentication policy describing a manner in which an end-user may access a managed service environment implemented by a computer network, further comprising:
designating at least one authentication policy describing a manner in which an end-user may access a managed service environment implemented by a computer network, wherein said at least one authentication policy comprises only one authentication policy.

7. The method of claim 1 wherein designating at least one authentication policy describing a manner in which an end-user may access a managed service environment implemented by a computer network, further comprising:
designating at least one authentication policy describing a manner in which an end-user may access a managed service environment implemented by a computer network, wherein said at least one authentication policy comprises a plurality of authentication policies.

8. The method of claim 1 further comprising configuring said computer network to comprise a digital services platform that includes a database comprising configuration data, user account data, resource permission data and an activity log accessible by said privileged administrator for configuration of said at least one authentication policy.

9. The method of claim 1 further comprising configuring said computer network to comprise a digital services platform through which a privileged administrator can configure said at least one authentication policy according to said preferences of said privileged administrator.

10. The method of claim 1 wherein said at least one authentication policy comprises a password authentication policy

11. A privileged administrator computer network authentication policy configuration method comprising:
initially designating at least one authentication policy describing a manner in which an end-user may access a managed service environment implemented by a computer network;
permitting a privileged administrator of said managed service environment to configure said at least one authentication policy according to a preference of said privileged administrator;
selecting said at least one authentication policy, in response to a particular input by said privileged administrator;
configuring said at least one authentication policy, in response to a particular input by said privileged administrator; and
thereafter automatically facilitating a resolution of at least one conflict arising from configuring said at least one authentication policy according to a preference of said privileged administrator.

12. The method of claim 11 further comprising configuring said computer network to comprise a digital services platform through which a privileged administrator can configure said at least one authentication policy according to said preferences of said privileged administrator.

13. The method of claim 12 further comprising configuring said digital services platform to include a database comprising configuration data, user account data, resource permission data and an activity log accessible by said privileged administrator for configuration of said at least one authentication policy.

14. A privileged administrator computer network authentication policy configuration system comprising:
an access management service module for associating with a computer network at least one authentication policy describing a manner in which an end-user may access a managed service environment implemented within said computer network;
wherein said access management service module permits a privileged administrator of said managed service environment to configure said at least one authentication policy according to a preference of said privileged administrator; and
wherein said at least one authentication policy is thereafter configurable, in response to a particular input by said privileged administrator.

15. The system of claim 14 said at least one authentication policy is selectable, in response to a particular input by said privileged administrator.

16. The system of claim 14 wherein said at least one authentication policy is disabled, in response to a particular input by said privileged administrator

17. The system of claim 14 wherein said at least one authentication policy is enabled, in response to a particular input by said privileged administrator.

18. The system of claim 14 wherein said access management service module automatically facilitates a resolution a plurality of conflicts arising from configuring said at least one authentication policy according to said preference of said privileged administrator.

19. The system of claim 14 wherein said computer network comprises a digital services platform that includes a database comprising configuration data, user account data, resource permission data and an activity log accessible by said privileged administrator for configuration of said at least one authentication policy.

20. The system of claim 14 wherein said computer network comprises a digital services platform through which a privileged administrator can configure said at least one authentication policy according to said preferences of said privileged administrator.
